(19) United States
(12) Patent Application Publication
(10) Pub. No.: US 2026/0361037 A1
(43) Pub. Date: Nov. 12, 2026

(54) High Voltage Interlock Connector System with Ground Path and Logic Circuit

(71) Applicant: TE Connectivity Solutions GmbH, Schaffhausen (CH)

(72) Inventors: Kyle Gary ANNIS, Hummelstown, PA (US); Michael Frank CINA, Elizabethtown, PA (US); Joshua Allen ROSENAU, York, PA (US)

(73) Assignee: TE Connectivity Solutions GmbH, Schaffhausen (CH)

(21) Appl. No.: 19/204,689

(22) Filed: May 12, 2025

(51) Int. Cl. H01R 13/703; H01R 13/64

(52) U.S. Cl. CPC H01R 13/7036; H01R 13/64; H01R 2201/26

(57) ABSTRACT

A high voltage interlock connector with at least one male high voltage receiving passage which extends therethrough. Contact receiving areas are positioned in the at least one male high voltage receiving passage. An insulator housing is positioned in the contact receiving area. The insulator housing has an outer wall which is dimensioned to engage an inner wall of the at least one male high voltage receiving passage to properly position and center the insulator housings in the at least one male high voltage receiving passage. The insulator housing includes a contact receiving passage which extends through the insulator housings, and a high voltage interlock contact receiving passage. The high voltage interlock contact receiving passage is spaced and distinct from the contact receiving passage. A high voltage contact is positioned in the contact receiving passage. A high voltage interlock contact is positioned in the high voltage interlock contact receiving passage.

### BACKGROUND OF THE INVENTION

The invention relates generally to a high voltage interlock (HVIL) connector assembly and system having a high voltage interlock contact which makes an electrical engagement with a ground structure of a plug connector. In addition, the invention relates to a high voltage connector assembly having a logic interlock on a printed circuit board to read high and low resistance.

Connectors may be used in high voltage applications, such as in hybrid or all-electric automobiles or aircrafts, to transfer relatively high voltage current from a power source to one or more electric loads. For example, connectors may electrically couple a battery with motors, heating elements, control systems, transmissions, and the like, in an automobile or aircraft. The high voltage current that is transmitted using these connectors may require safeguards to ensure that operators of the automobile and other electronic components in the automobile are not harmed by the current.

Due to the high voltage and large amperage involved, it is a prerequisite to shut down the high voltage circuit in question before a technician or other individual disconnects any high voltage connector. To prevent premature physical contact with the high voltage circuit, interlock loop circuitry, often referred to as high voltage interlock loops (HVIL), have been devised which when triggered will activate a shut-off program to shut down the high voltage circuit. One such trigger is an interlock loop connector in the HVIL circuit that often is piggybacked onto the high voltage connectors to allow the high voltage electrical circuit to shut down and adequately discharge after the HVIL circuit becomes disconnected but before the connector housing of the high voltage connector assembly can become disconnected.

Existing HVIL solutions use a traditional pin and socket and require alignment of the pin connector to the receptacle prior to mating. This is particularly problematic when operating in constrained spaces given the connector must be terminated prior to being fed through the vehicle/aircraft, meaning that the user has to “twist” the connector to ensure the mating halves of the connector can be fully mated.

It would, therefore, be beneficial to provide a high voltage, sealed and shielded power connector assembly with a HVIL circuit having an HVIL contact in the receptacle connector that can make an electrical engagement with any point of the shell of the plug connector to complete the circuit.

### SUMMARY OF THE INVENTION

An object is to provide an HVIL system which eliminates the need for orienting the plug connector and the receptacle connector prior to mating, while still meets the HVIL requirement for safety.

An object is to provide an HVIL system which eliminates contacts from the plug connector, making the plug connector more robust that traditional HVIL solutions.

An object is to provide an HVIL system in which the HVIL contacts are connected to a printed circuit board which allows the system to be powered only when the circuit is complete.

An embodiment is directed to a high voltage interlock connector which includes a housing having an outer shell with at least one male high voltage receiving passage which extends therethrough. Contact receiving areas are positioned in the at least one male high voltage receiving passage. An insulator housing is positioned in the contact receiving area. The insulator housing has an outer wall which is dimensioned to engage an inner wall of the at least one male high voltage receiving passage to properly position and center the insulator housings in the at least one male high voltage receiving passage. The insulator housing includes a contact receiving passage which extends through the insulator housings, and a high voltage interlock contact receiving passage. The high voltage interlock contact receiving passage is spaced and distinct from the contact receiving passage. A high voltage contact is positioned in the contact receiving passage. A high voltage interlock contact is positioned in the high voltage interlock contact receiving passage. As the high voltage interlock connector assembly is mated with a mating high voltage connector, the high voltage contact of the high voltage interlock connector assembly and a mating high voltage contact of the mating high voltage connector are not energized until the high voltage interlock contact of the high voltage interlock connector assembly is placed in electrical engagement with a ground shell of the mating high voltage contact and an high voltage interlock circuit is closed.

An embodiment is directed to a high voltage interlock system having a high voltage interlock connector assembly and a voltage interlock circuit. The high voltage interlock connector assembly has a housing with a high voltage receiving passage extending therethrough. An insulator housing is positioned in the high voltage receiving passage. The insulator housing has a contact receiving passage which extends through the insulator housings and a high voltage interlock contact receiving passage. The high voltage interlock contact receiving passage being spaced and distinct from the contact receiving passage. A high voltage contact is positioned in the contact receiving passage. A high voltage interlock contact is positioned in the high voltage interlock contact receiving passage. The voltage interlock circuit has a circuit board connected to the high voltage interlock contact. The circuit board has a logic interlock. When the voltage interlock circuit is closed, the logic interlock reads low resistance and allows high voltage contact to be energized.

An embodiment is directed to a method of energizing high voltage contacts in a high voltage interlock system, the method comprising: mating a first high voltage connector assembly to a second high voltage connector assembly; determining by a voltage interlock circuit if all high voltage interlock contacts housed in the first high voltage connector are in electrical engagement with grounding shells of second high voltage contacts of the second high voltage connector assembly, thereby closing the voltage interlock circuit; energizing the second high voltage contacts and mated first high voltage contacts of the first high voltage connector assembly if the voltage interlock circuit is closed; and deenergizing the second high voltage contacts and the first high voltage contacts if the voltage interlock circuit is open.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a back perspective view of an illustrative high voltage interlock connector assembly of the present invention, showing a first male or plug connector inserted into a receptacle or header connector and a second male or plug connector prior to insertion into the receptacle or header connector.

FIG. 2 is a front perspective view of the illustrative receptacle or header connector of FIG. 1.

FIG. 3 is a front view of the illustrative receptacle or header connector of FIG. 1.

FIG. 4 is a partial exploded view of the illustrative receptacle or header connector of FIG. 1.

FIG. 5 is a cross-sectional view of the illustrative receptacle or header connector, taken along line 5-5 of FIG. 2.

FIG. 6 is a front perspective view of an illustrative male or plug connector of FIG. 1.

FIG. 7 is a cross-sectional view of the illustrative male or plug connector, taken along line 7-7 of FIG. 6.

FIG. 8 is a cross-sectional view of the male or plug connector inserted into the receptacle or header connector, taken along line 8-8 of FIG. 1.

FIG. 9 is an enlarged view of section 9 of FIG. 8.

FIG. 10 is an illustrative view of a high voltage contact of the receptacle or header connector in electrical engagement with a shell of the male or plug connector, the housing of the receptacle or header connector has been removed to more clearly show the engagement of the contact with the shell.

FIG. 11 is a diagrammatic view of the HVIL circuit.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

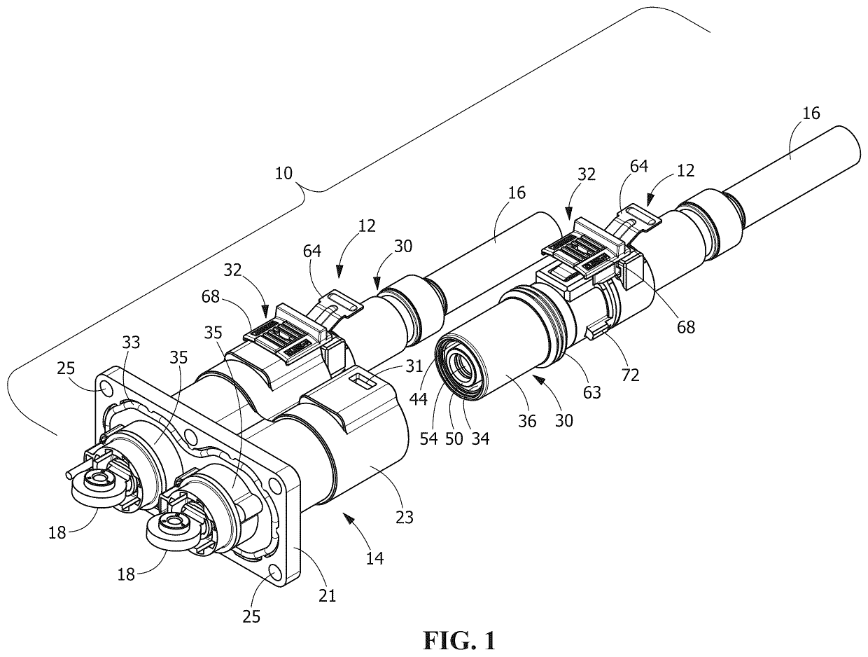

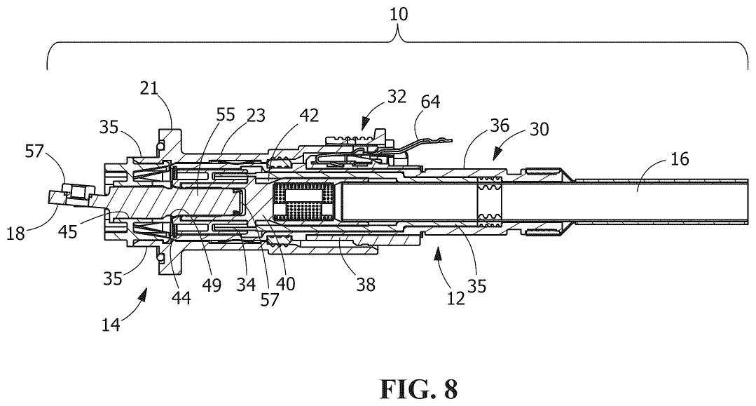

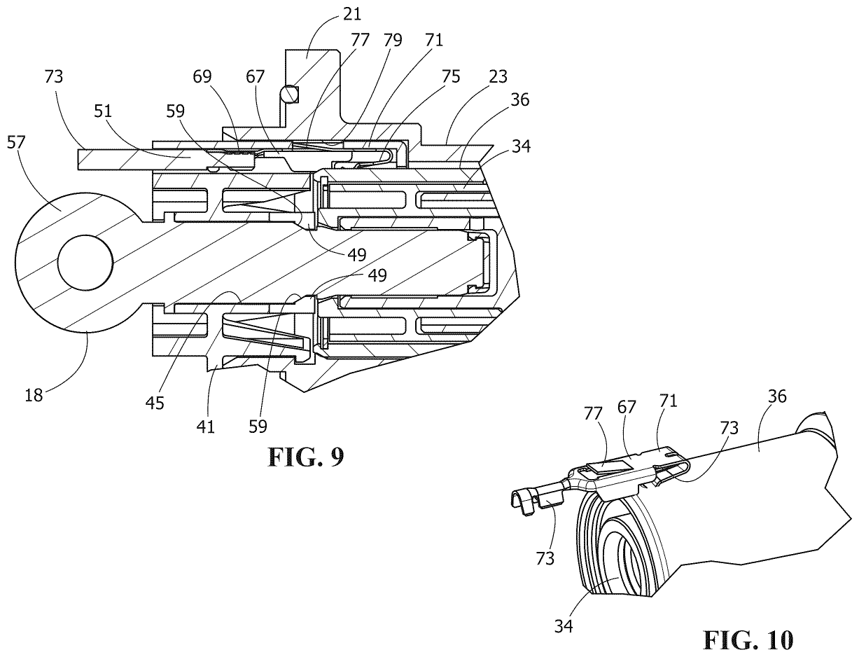

As shown in FIGS. 1 and 8, a high voltage and HVIL connector assembly 10 is shown with a first or male plug high voltage connector or assembly 12 and a second or female receptacle high voltage header or assembly 14. A high voltage wire 16 extends from the male high voltage assembly 12 and a high voltage terminal 18 extends from the female high voltage assembly 14. When the male high voltage assembly 12 is properly inserted into the female high voltage assembly 14, the high voltage wires 16 makes an electrical connection with the high voltage terminal 18 to form a part of a high voltage circuit.

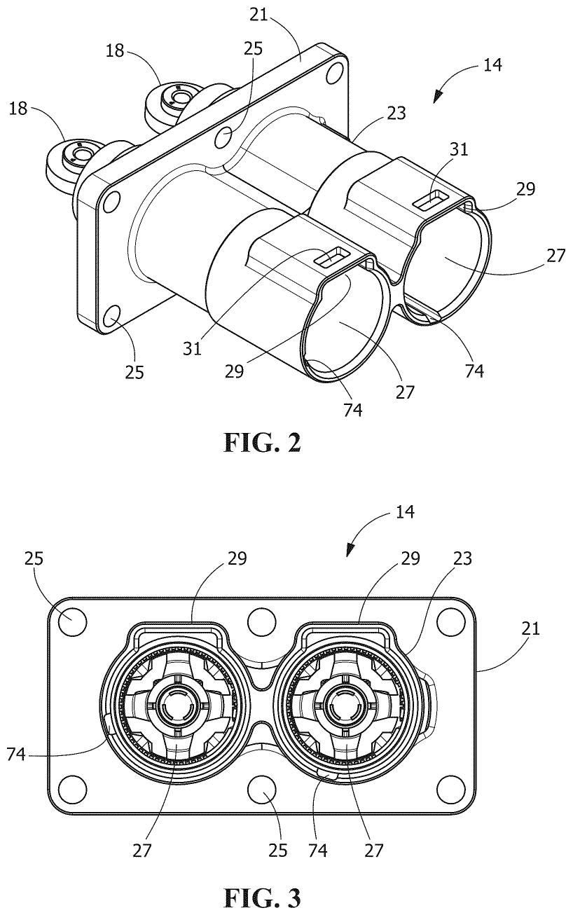

As shown in FIGS. 1 through 5, the second or female receptacle high voltage header or assembly 14 has a panel mounting member 21 with an outer shell 23 extending therefrom. In the illustrative embodiment, the panel mounting member 21 is a generally planar member with mounting openings 25 extending therethrough. A longitudinal axis of the outer shell 23 extends essentially perpendicular to a longitudinal axis of the panel mounting member 21. The outer shell 23 may be formed of nickel plated aluminum or other similar materials.

In the embodiment shown, the outer shell 23 has two male high voltage receiving passages 27. Each of the male high voltage receiving passages 27 has a latch receiving portion 29 with a latch receiving opening 31. An alignment keying recess 74 is provided in each receiving passage 27. The positioning of the keying recess 74 in each receiving passage 27 may vary to provide for proper keying.

On the side of the panel mounting member 21 opposite the outer shell 23, an O-ring 33 extends about contact receiving areas 35 which extend from the panel mounting member 21. The O-ring 33 provide environmental sealing. However other types of seals may be used.

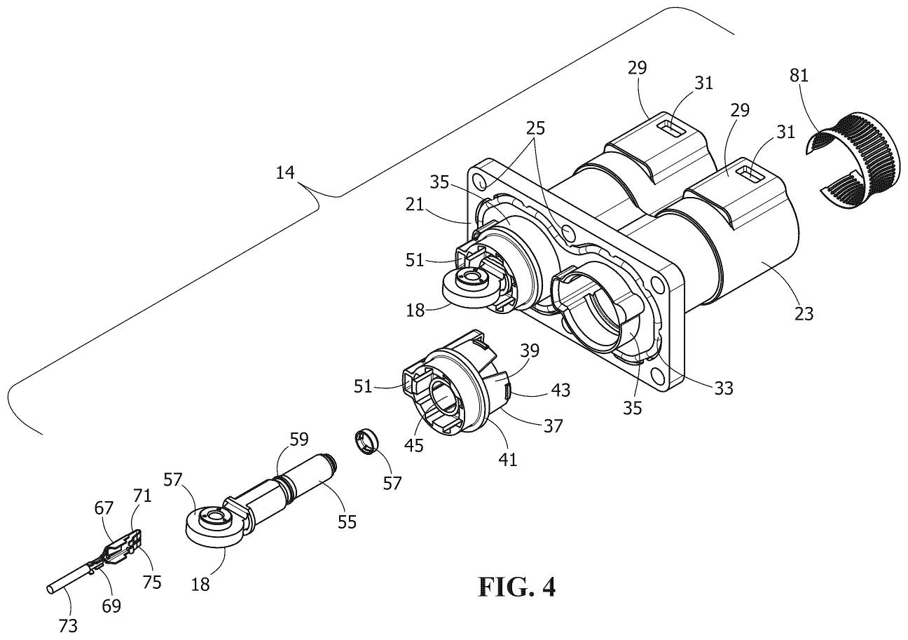

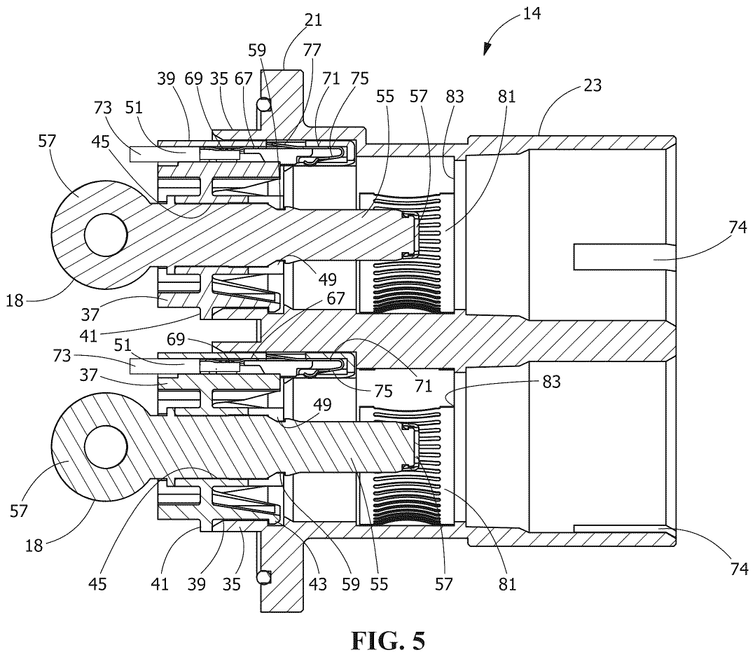

As shown in FIGS. 4 and 5, an insulator housing 37 is positioned in each of the contact areas 35. The insulator housings 37 have outer walls 39 which are dimensioned to engage in the inner walls of the contact receiving areas 35 to properly position and center the insulator housings 37. The insulator housings have a positioning projection 41 and locking tabs 43 which facilitate the positioning of the insulator housings 37 in the contact receiving areas 35 and prevent the unwanted removal of the insulator housings 37.

A contact receiving passage 45 extends through each of the insulator housings 27. The contact receiving passages 45 having inner walls 47 with contact securing tabs 49 projecting into the contact receiving passages 45. In the illustrative embodiment shown, the contact receiving passages 45 are generally centered in the insulator housings 37.

An HVIL contact receiving passage 51 is also provided in each of the insulator housings 27. The HVIL contact receiving passages 51 are spaced from and distinct from the contact receiving passages 45. The HVIL contact receiving passage 51 are positioned proximate to the perimeter of the insulator housings 27.

High voltage terminals or pin contacts 18 are positioned in each of the contact receiving passages 45. The pin contacts 18 have mating ends 55 for mating with the mating ends 44 of the socket contacts 40 of the male high voltage assemblies 12. Touch proof caps 57 are provided at the ends of the mating ends 55 for safety. The mating ends 55 extend into the high voltage receiving passages 27 when fully assembled. Busbar attachments 57 are provided on the pin contacts 18 at the opposite ends from the mating ends 55. Securing recesses 59 extend about the circumference of the pin contacts 18 and are positioned between the mating ends 55 and the busbar attachments 57. The securing recesses 59 cooperate with the contact securing tabs 49 to secure the pin contacts 18 in position.

HVIL contacts 67 are positioned in each of the HVIL contact receiving passages 51. The HVIL contacts 67 have crimp portions 69 and mating portions 71. Wires 73 are crimped to the crimp portions 69. The mating portions 71 have resilient members 75 which extend into the high voltage receiving passages 27 when fully assembled. Retention members 77 extend from the HVIL contacts 67 HVIL contacts 67 in a direction away from the resilient members 75. The retention members 77 engage recesses 79 in the wall of the HVIL contact receiving passages 51 to prevent the unwanted removal of the HVIL contacts 67 from the HVIL contact receiving passages 51.

Ground louvers 81 are positioned in the male high voltage receiving passages 27. The ground louvers 81 are maintained in position by recesses 83 provided in the male high voltage receiving passages 27.

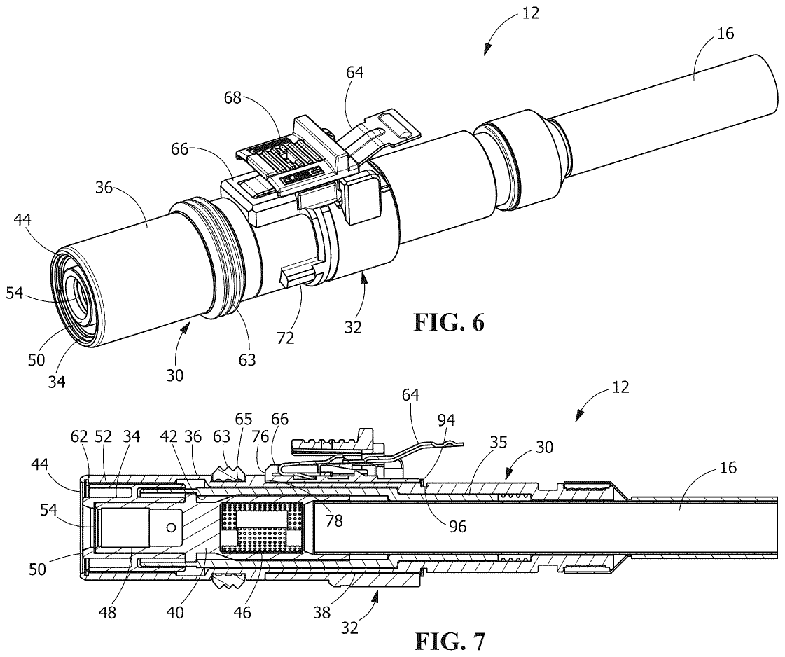

Referring to FIGS. 6 and 7, the male high voltage assembly 12 has an inner component 30 and an outer component 32 which is rotatably mounted to the inner component 30. In the illustrative embodiment shown, the inner component 30 includes an front insulator 34 and a rear insulator 35 with a grounding/shielding member 36 which is positioned about the outer circumference of the front insulator 34 and the rear insulator 35. The grounding/shielding member 36 has an outer component receiving recess 38 (FIG. 7) which extends about an outer circumference of the grounding/shielding member 36.

A socket contact 40 is positioned a conductor receiving passage 42 of the inner component 30 proximate a mating end 44. The socket contact 40 has a conductor receiving end 46 and a mating contact receiving end 48. The mating contact receiving end 48 may have a louver contact section (not shown), however, other types of contact sections may be used.

A centering member 50 is positioned on the front insulator 34 in the conductor receiving passage 42 proximate the mating end 44. The centering member 50 has an outer wall 52 which cooperates with an inner wall of the conductor receiving passage 42. A socket contact receiving passage 54 extends through the centering member 50 and is positioned along a longitudinal axis of the centering member 50. When assembled, the outer wall 52 of the centering member 50 engages the inner wall of the conductor receiving passage 42 and the socket contact receiving passage 54 engages the conductor receiving end 46 of the socket contact 40 to properly center the socket contact 40.

A retaining ring 60 is provided proximate the mating end 44 of the housing. The retaining ring 60 is positioned in a retaining ring receiving recess 62 which extends about an inner circumference of the grounding/shielding member 36. The retaining ring 60 cooperates with the centering member 50 to maintain the centering member 50 in position in the conductor receiving passage 42.

A peripheral environmental seal 63 is provided in a seal recess 65 which extends about the outer circumference of the grounding/shielding member 36. The environmental seal 63 is configured to cooperate with the female high voltage assembly 14 to prevent the ingress of moisture and other contaminates when the male high voltage assembly 12 is mated with the female high voltage assembly 14.

As shown in FIGS. 6 through 8, the outer component 32 is a cylindrical member which is positioned in the outer component receiving recess 38 of the grounding/shielding member 36. The outer component 32 has a latch 64 which extends from an outer surface 66 of the outer component 32 in a direction away from the inner component 30. The latch 64 has a connector position assurance member 68.

In the illustrative embodiment, an alignment keying projection 72 is provided on outer component 32 and is spaced from the latch 64. The alignment keying projection 72 extends from the outer surface 66 of the outer component 32 in a direction away from the inner component 30. The particular configuration and spacing of the alignment keying projection 72 is dependent upon the configuration and spacing of an alignment keying recess 74 which is provided on the female high voltage assembly 14.

As shown in FIG. 7, the outer component 32 has one or more locking projections 94 which cooperate with a locking projection receiving recess 96. As the outer component 32 is inserted into the outer component receiving recess 38 from the conductor receiving end 58 of the housing 34, the outer component 32 is moved toward the mating end 44 of the housing 34 until a leading edge 76 of the outer component 32 engages a shoulder 78 of the outer component receiving recess 38, there preventing further movement of the outer component 32 toward the mating end 44. As this occurs, the one or more locking projections 94 are moved into the locking projection receiving recess 96, thereby preventing the movement of the outer component 32 back toward the conductor receiving end 58 of the housing 34. With the one or more locking projections 94 properly positioned in the locking projection receiving recess 96, the outer component 32 is secured to the inner component 30 in such a manner that the outer component 32 can rotate about the inner component 30.

The use of a rotatably mounted outer component 32 allows the outer component 32 to rotate independently of the inner component 30 and the high voltage wire 16. As the high voltage wire 16 can be of a large size, the independent rotation of the outer component 32 allows the user to rotate the outer component 32 to make the connection between the male high voltage assembly 12 and a female high voltage assembly 14, without the need to rotate or twist the inner housing 30 and the wire high voltage wire 16 to a specific orientation.

When mating the first or male high voltage assembly 12 to the second or female high voltage assembly 14, the grounding/shielding member 36 of the inner component 30 of the first high voltage assembly 12 is placed an electrical and mechanical connection with the HVIL contacts 67 of the second high voltage assembly 14. As mating occurs, the grounding/shielding member 36 of the inner component 30 of the first high voltage assembly 12 engages the resilient members 75 of the HVIL contacts 67, causing he resilient members 75 to be elastically deformed. In so doing, the resilient members 75 of the HVIL contacts 67 exert a force and wipe across the grounding/shielding member 36 to ensure that the resilient members 75 and the grounding/shielding members 36 are placed in electrical engagement.

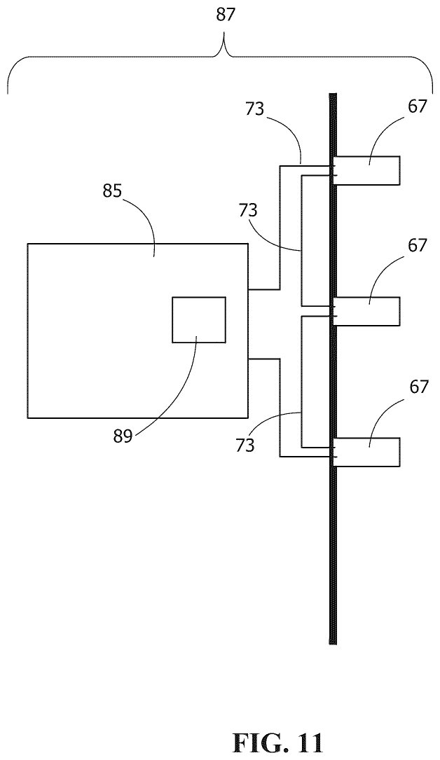

As mating occurs, the mating contact receiving end 48 of the socket contact 40 of the first high voltage assembly 12 is placed in electrical and mechanical connection with the mating ends 55 of the high voltage pin contacts 18 of the second high voltage assembly 14. However, until the HVIL circuit 87 (FIG. 11) is closed, the high voltage circuit of the first or male high voltage assembly 12 and the second or female high voltage assembly 14 is not energized. This prevents accidental exposure to the high voltage circuit and prevents arcing between the high voltage contacts of the first or male high voltage assembly 12 and the second or female high voltage assembly 14 during mating.

Referring to FIG. 11, the HVIL circuit 87 includes a circuit board 85, wires or other types of connections 73 and the HVIL contacts 67. A logic interlock 89 or the circuit board 85 is configured to read high resistance (open) vs. low resistance (closed). The HVIL circuit 87 remains open until all of the HVIL contacts 67 are placed in electrical engagement with respective grounding/shielding members 36. As the grounding/shielding members 36 are commoned with the assemblies, a logic interlock 89 on the circuit board 85 read low resistance. Once low resistance is obtained, the high voltage contacts in the first or male high voltage assembly 12 and the second or female high voltage assembly 14 are energized. In the embodiment shown, respective connections 73 extend from each of the HVIL contacts 67 to the circuit board 85 and the logic interlock 89.

During unmating or during operation, when one HVIL contacts 67 becomes disconnected from a grounding/shielding member 36, the logic interlock 89 on the circuit board 58 of the HVIL circuit 87 reads high resistance. With a reading of high resistance, the high voltage contacts in the first or male high voltage assembly 12 and the second or female high voltage assembly 14 are deenergized. This prevents accidental exposure to the high voltage circuit and prevents arcing between the high voltage contacts of the first or male high voltage assembly 12 and the second or female high voltage assembly 14 during unmating.

A method of energizing high voltage contacts 16, 18 in a high voltage interlock system 10 includes mating a first high voltage connector assembly 12 to a second high voltage connector assembly 14. Determining by a voltage interlock circuit 87 if all high voltage interlock contacts 67 housed in the second high voltage connector 14 are in electrical engagement with grounding shells 36 of first high voltage contacts 16 of the first high voltage connector assembly 12, thereby closing the voltage interlock circuit 87. Energizing the second high voltage contacts 18 and mated first high voltage contacts 16 if the voltage interlock circuit 87 is closed, and deenergizing the second high voltage 18 contacts and the first high voltage contacts 16 if the voltage interlock circuit 87 is open.

The high voltage and HVIL connector assembly 10 prevents unwanted and undesirable premature connection of the low voltage HVIL circuit while also preventing unwanted and undesirable premature disconnection of a high voltage circuit of an electrically driven motor vehicle before the low voltage circuit is disconnected.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A high voltage interlock connector assembly comprising:
a housing having an outer shell with at least one male high voltage receiving passage extending therethrough, contact receiving areas positioned in the at least one male high voltage receiving passage;
an insulator housing positioned in the contact receiving area, the insulator housing having an outer wall which is dimensioned to engage an inner wall of the at least one male high voltage receiving passage to properly position and center the insulator housings in the at least one male high voltage receiving passage, the insulator housing comprising:
a contact receiving passage extending through the insulator housings; and
a high voltage interlock contact receiving passage, the high voltage interlock contact receiving passage being spaced and distinct from the contact receiving passage;
a high voltage contact positioned in the contact receiving passage;
a high voltage interlock contact positioned in the high voltage interlock contact receiving passage;
wherein as the high voltage interlock connector assembly is mated with a mating high voltage connector, the high voltage contact of the high voltage interlock connector assembly and a mating high voltage contact of the mating high voltage connector are not energized until the high voltage interlock contact of the high voltage interlock connector assembly is placed in mechanical and electrical engagement with a ground shell of the mating high voltage contact and an high voltage interlock circuit is closed.

2. The high voltage interlock connector assembly as recited in claim 1, wherein the housing has a panel mount member from which the outer shell extends, a longitudinal axis of the outer shell extends essentially perpendicular to a longitudinal axis of the panel mounting member.

3. The high voltage interlock connector assembly as recited in claim 1, wherein the at least one male high voltage receiving passage is two male high voltage receiving passages.

4. The high voltage interlock connector assembly as recited in claim 1, wherein the at least one male high voltage receiving passage has a latch receiving portion with a latch receiving opening.

5. The high voltage interlock connector assembly as recited in claim 1, wherein the at least one male high voltage receiving passage has an alignment keying recess.

6. The high voltage interlock connector assembly as recited in claim 1, wherein the insulator housing has a positioning projection and locking tabs which facilitate the positioning of the insulator housings in the contact receiving areas and prevent the unwanted removal of the insulator housings.

7. The high voltage interlock connector assembly as recited in claim 1, wherein the contact receiving passage has an inner wall with contact securing tabs projecting into the contact receiving passages.

8. The high voltage interlock connector assembly as recited in claim 1, wherein the high voltage interlock contact receiving passage is positioned proximate to the perimeter of the insulator housing.

9. The high voltage interlock connector assembly as recited in claim 1, wherein the high voltage contact has a mating end which extends into the at least one male high voltage receiving passage, the mating end is configured to mate with a socket contacts of a mating high assembly.

10. The high voltage interlock connector assembly as recited in claim 1, wherein a securing recess extends about the circumference of the high voltage contact, the securing recess cooperates with the contact securing tabs to secure the high voltage contact in position.

11. The high voltage interlock connector assembly as recited in claim 1, wherein the high voltage interlock contact has a mating portion with a resilient member which extends into the high voltage receiving passages.

12. The high voltage interlock connector assembly as recited in claim 1, wherein the high voltage interlock contact has a wire receiving portion with a wire extending therefrom.

13. The high voltage interlock connector assembly as recited in claim 1, wherein the high voltage interlock contact has a retention member which engages a recess in a wall of the high voltage interlock contact receiving passage.

14. The high voltage interlock connector assembly as recited in claim 1, wherein a ground louver is positioned in the at least one male high voltage receiving passage.

15. The high voltage interlock connector assembly as recited in claim 1, wherein the high voltage interlock circuit has a circuit board with a logic interlock which is configured to i) read low resistance when the high voltage interlock contact is in electrical engagement with the ground shell of the mating high voltage contact and read high resistance when the high voltage interlock contact is not in electrical engagement with the ground shell of the mating high voltage contactor or ii) read high resistance when the high voltage interlock contact is in electrical engagement with the ground shell of the mating high voltage contact and read low resistance when the high voltage interlock contact is not in electrical engagement with the ground shell of the mating high voltage contactor.

16. A high voltage interlock system comprising:
a high voltage interlock connector assembly comprising:
a housing having a high voltage receiving passage extending therethrough;
an insulator housing positioned in the high voltage receiving passage, the insulator housing having one or more contact receiving passages extending through the insulator housings and one or more high voltage interlock contact receiving passages, the one or more high voltage interlock contact receiving passages being spaced and distinct from the one or more contact receiving passages;
one or more high voltage contacts positioned in the one or more contact receiving passages;
one or more high voltage interlock contacts positioned in the one or more high voltage interlock contact receiving passage;
a voltage interlock circuit having a circuit board connected to the one or more high voltage interlock contacts, the circuit board having a logic interlock;
wherein when the voltage interlock circuit is closed, the logic interlock reads low resistance and allows high voltage contact to be energized.

17. The high voltage interlock system as recited in claim 16, wherein the one or more high voltage interlock contacts have mating portions with resilient members which extend into the high voltage receiving passages.

18. The high voltage interlock system as recited in claim 16, wherein the high voltage interlock contacts have wire receiving portions with wires extending therefrom.

19. The high voltage interlock system as recited in claim 16, respective wires extend from each of one or more high voltage interlock contacts to the circuit board.

20. A method of energizing high voltage contacts in a high voltage interlock system, the method comprising:
mating a first high voltage connector assembly to a second high voltage connector assembly;
determining by a voltage interlock circuit if all high voltage interlock contacts housed in the first high voltage connector are in electrical engagement with grounding shells of second high voltage contacts of the second high voltage connector assembly, thereby closing the voltage interlock circuit;
energizing the second high voltage contacts and mated first high voltage contacts of the first high voltage connector assembly if the voltage interlock circuit is closed; and
deenergizing the second high voltage contacts and the first high voltage contacts if the voltage interlock circuit is open.
